(19) United States
(12) Patent Application Publication
(10) Pub. No.: US 2008/0244272 A1
(43) Pub. Date: Oct. 2, 2008

(54) HAND CRYPTOGRAPHIC DEVICE

(75) Inventors: Chih-Tao Hsieh, Shijr City (TW); Chieh-Kwei Lee, Shijr City (TW)

Correspondence Address: MADSON & AUSTIN, 15 WEST SOUTH TEMPLE, SUITE 900, SALT LAKE CITY, UT, 84101, US

(73) Assignee: Aten International Co., Ltd., Shijr City (TW)

(21) Appl. No.: 11/695,981

(22) Filed: Apr. 3, 2007

(51) Int. Cl. H04L 9/00

(52) U.S. Cl. 713/184; 380/52

(57) ABSTRACT

Disclosed is a hand cryptographic device for keeping a secret code inside confidential and being convenient to be carried about. The hand cryptographic device of the present invention includes an input module, a memory and a user interface. The input module is used for being inputted the secret code and a command of accessing the secret code. The memory stores a control program of the hand cryptographic device and the inputted secret code. The user interface provides the secret code to the user when the user inputs the command of accessing the secret code. The input module may comprise a keypad device for inputting the command of accessing the secret code.

### FIELD OF THE INVENTION

The present invention generally relates to a hand cryptographic device for keeping secret codes inside confidential and being convenient to be carried about.

### BACKGROUND OF THE INVENTION

In this computer world, people may have many sets of secret codes as password to access bank count, shopping website and etc. on the Internet. In some other situation, people may also set a secret code to lock files, a personal computer system, a server and etc. for keeping information stored inside confidential. By involving with aforesaid digital communication more deeply, people own more and more sets of secret codes even people themselves would be confused with the dozens of secret codes they have.

Therefore, a hand cryptographic device can be a solution for helping people not to be confused with lots of secret codes of their own with their memory only. Especially, for people who cannot see or people who cannot hear may need some special designs of the hand cryptographic device for easier operation

Consequently, there is a need to develop a hand cryptographic device for keeping secret codes inside confidential and being convenient to be carried about.

### SUMMARY OF THE INVENTION

To solve the foregoing drawbacks in the prior art, it is an objective of the present invention is to provide a hand cryptographic device for keeping secret codes inside confidential and being convenient to be carried about. The hand cryptographic device of the present invention includes an input module, a memory and a user interface. The input module is used for being inputted a secret code and a command of accessing the secret code. The memory stores the inputted secret code. The user interface provides the secret codes stored in the memory when the user inputs the command of accessing the secret code. The memory further stores a control program of the hand cryptographic device. The input module may include a keypad device for inputting the command of accessing the secret code. The input module may include a microphone to receive a voice and then, the control program transforms the voice into the secret code or the command of accessing the secret code. Alternatively, the input module may include a fingerprint access device to scan the fingerprint of the user as the command of accessing the secret code.

For going with the design alternation of the input module, the user interface can be a LCD display, a speaker or a Braille display to “show” the secret codes for the user. The hand cryptographic device may further include a communication interface to couple the hand cryptographic device of the present invention with a computer. Then, the user can input the secret code and the command of accessing the secret code via the computer. Accordingly, a corresponding software program should be installed in the computer to allow the user control the hand cryptographic device.

### BRIEF DESCRIPTION OF THE DRAWINGS

FIG. 1 illustrates a functional block diagram of a hand cryptographic device according to the present invention;

FIG. 2 illustrates a drawing of a hand cryptographic device according to a first embodiment of the present invention;

FIG. 3 illustrates a drawing of a hand cryptographic device according to a second embodiment of the present invention; and

FIG. 4 illustrates a drawing of a hand cryptographic device according to a third embodiment of the present invention.

### DETAILED DESCRIPTION OF THE INVENTION

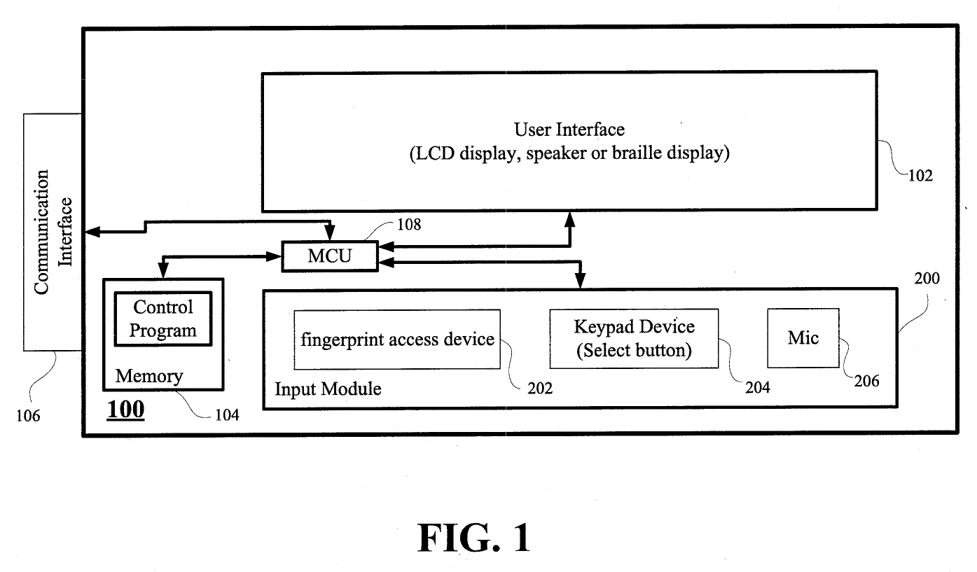

Please refer to FIG. 1, which illustrates a functional block diagram of a hand cryptographic device 100 according to a preferred embodiment of the present invention. The hand cryptographic device 100 at least includes a micro control unit (MCU) 108, a user interface 102, a memory 104, and an input module 200. The memory 104 stores at least one inputted secret code and also stores a control program of the hand cryptographic device 100. The user interface 102 provides at least the secret code to the user when the user inputs a command of accessing at least the secret code The command of accessing at least the secret code includes a command of storing a new secret code, a command of revising the stored secret code, a command of deleting the stored secret code, a command of showing the stored secret code and the combination thereof. The input module 200 is used for being inputted the secret code and the command of accessing at least the secret code.

The input module 200 may include a fingerprint access device 202 to scan the fingerprint of the user and then, the MCU 108 uses the control program in the memory 104 to recognize the fingerprint of the user as the command of accessing the secret code after the fingerprint of the user is recognized by the MCU 108 as a correct fingerprint pre-stored in the memory 104. That is, the MCU 108 recognizes whether a scanned fingerprint is the correct fingerprint pre-stored in the memory 104. The input module 200 may include keypads 204 for being inputted the command of accessing the secret codes. Alternatively, the input module 200 may include a microphone 206 to receive a voice of the user and then, the MCU 108 uses the control program in the memory 104 to transform the voice into the secret code or the command of accessing the secret code.

For going with the design alternation of the input module 200, the user interface 102 can be a flat panel (LCD/OLED) display, a speaker, a Braille display or the combinations thereof to “show” the secret code stored in the memory 104. The hand cryptographic device 100 may further include a communication interface 106 to couple the hand cryptographic device 100 of the present invention with a computer or a portable electronic device (not shown in FIG. 1). Then, the user also can input, manage the secret codes and input the command of accessing the secret codes via the computer or the portable electronic device. Accordingly, a corresponding software program should be installed in the computer or the portable electronic device to allow the user control the hand cryptographic device 100. MCU 108 is used for controlling the work of the memory 104, the input module 200 and the user interface 102. That is, the MCU 108 is used for controlling the memory 104 to store the secret code while receiving the secret code from the input module 200, and for controlling the user interface 102 to provide the secret code stored in the memory 104 while receiving the command of accessing the secret code form the input module 102. In one embodiment, the communication interface 106 may be a USB interface, an IEEE 1394 interface and the like. It is to be understood that the hand cryptographic device 100 further includes a storage unit to store data when the hand cryptographic device 100 is used as a portable storage device.

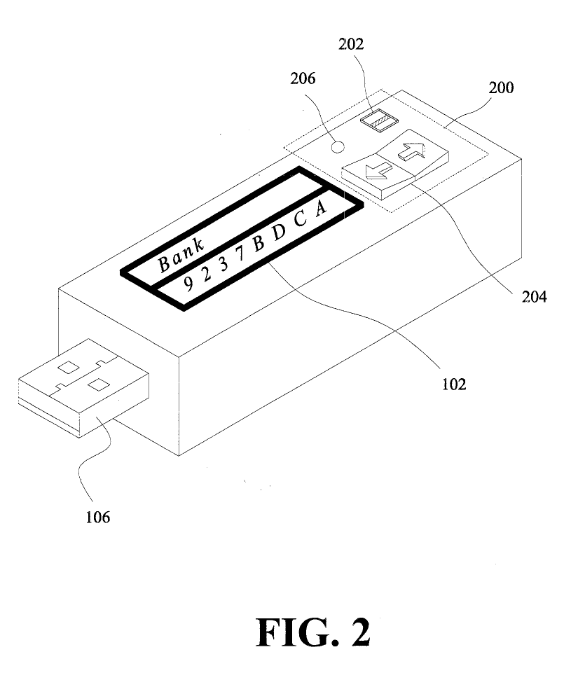

Please refer to FIG. 2, which illustrates a drawing of a hand cryptographic device according to a first embodiment of the present invention. The hand cryptographic device in this embodiment includes a LCD display 102 (user interface), a USB plug 106 and an input module 200. The USB plug 106 is used as the communication interface for coupling the hand cryptographic device 100 with the computer or the portable electronic device. The input module 200 may include at least one of the fingerprint access device 202, the keypads 204 and the microphone 206 for meeting requirements from different people. For example, the keypads 204 and the microphone 206 are enough for the user to input the secret code, the command of accessing the secret code and then, the MCU 108 shown in FIG. 1 receives the inputted command and shows the secret code on the LCD display 102 for the user to confirm. The user can trigger the fingerprint access device 202 to enable the MCU 108 shown in FIG. 1 stores the inputted secret code in the memory 104 shown in FIG. 1. In one embodiment, the LCD display 120 can be a touch panel for the user to input the secret code or the command of accessing the secret code, and the keypads 204 and the microphone 206 can be omitted.

As will be explained/described hereinafter in more detail. For example, the upper line of the display 102 is user item to show the information, the name for the corresponding secret code and the lower line of the display 102 is the password line to show the secret code. When the user is going to input a secret code, he uses the keypads 204 to select each code (A˜Z, 0˜9) from the left to the right of the display 102 and then, pushes the two ways of keypads 204 at the same time or scan his fingerprint via the fingerprint access device 202 to enter the code such as the first code “9” shown in FIG. 2. It is similar to the abovementioned character inputting operation that the user can complete the secret code “9237BDCA” and the user item “Bank” shown in FIG. 2 letter by letter from left header to right trail. The secret code “9237BDCA” and the user item “Bank” are corresponding to each other and can be combined to form as a set of item code. The user can enter either the user item “Bank” or the secret code “9237BDCA” first and enter the other later. In another embodiment, the user can select ending character “END” displayed in the password line in the display 102 after the secret code “9237BDCA” when the user have finished the action of inputting the secret code “9237BDCA”. In another embodiment, if the display 102 is a touch panel type display, the user can directly enter the user item or the secret code as a password via the display.

Moreover, the user can enter the user item and the secret code through the microphone 206 with a voice thereof. The user can enter either the user item “Bank” or the secret code first and enter the other later. The MCU 108 shown in FIG. 1 uses the control program in the memory 104 shown in FIG. 1 to recognize the voice and then show the user item and the secret code on the display 102. After the user confirmed that the user item and the secret code are right, he or she can push the two ways of keypads 204 at the same time or scan his or her fingerprint via the fingerprint access device 202 to enter, save the user item and the secret code in the memory 104 shown in FIG. 1. Afterward, the user can scan his fingerprint via the fingerprint access device 202 to access the memory 104 shown in FIG. 1 and use the keypads 204 to selectively show the desired user item with the corresponding secret code on the display 102. Then, the user can revise the set of item code or delete the set of item code. It is to be understood that the display 102 has the password line, and the item line can be omitted. Besides, the keypads 204 can include at least one functional/navigation button.

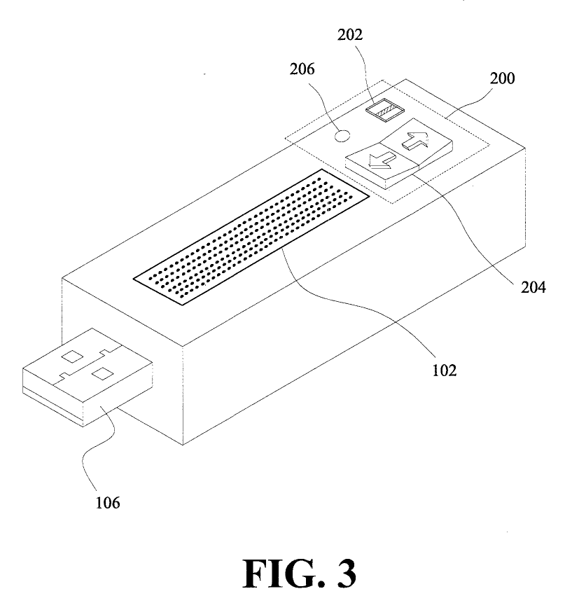

Please refer to FIG. 3, which illustrates a drawing of a hand cryptographic device according to a second embodiment of the present invention. The hand cryptographic device in this embodiment includes a speaker 102 (user interface), a USB plug 106 and an input module 200. As aforementioned, the USB plug 106 is used as the communication interface for coupling the hand cryptographic device 100 with the computer or the portable electronic device. The microphone 206 of the input module 200 can be used for inputting a secret code, the command of accessing the secret code and then, the MCU 108 shown in FIG. 1 uses the control program in the memory 104 shown in FIG. 1 to receive the command inputted by the people and the secret codes are played as voices one or more times by the speaker 102 for the people to confirm.

As will be explained/described hereinafter in more detail. For example, the user can enter the user item and the secret code through the microphone 206 with a voice thereof. The secret code can be played as voices one or more times by the speaker 102. The user can push the two ways of keypads 204 at the same time or scan his fingerprint via the fingerprint access device 202 to enter, save the user item and the secret code in the memory 104 shown in FIG. 1. Afterward, the user can scan his fingerprint via the fingerprint access device 202 to enable the MCU 108 shown in FIG. 1 to access the memory 104 shown in FIG. 1 and then control the speaker 102 to play the stored secret codes as voices by turns for the user to have the desired information.

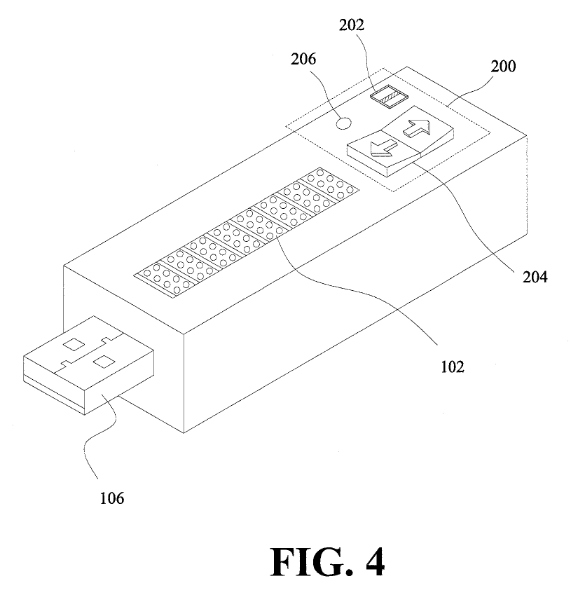

Please refer to FIG. 4, which illustrates a drawing of a hand cryptographic device according to a third embodiment of the present invention. The hand cryptographic device in this embodiment includes a Braille display 102 (user interface), a USB plug 106 and an input module 200. As aforementioned, the USB plug 106 is used as the communication interface for coupling the hand cryptographic device 100 with the computer or the portable electronic device the microphone 206 of the input module 200 can be used for inputting secret codes, the command of accessing the secret codes and then, the MCU 108 shown in FIG. 1 uses the control program in the memory 104 shown in FIG. 1 to receive the command inputted by the people and the secret code can be shown by the Braille display 102 for the people to confirm.

As will be explained/described hereinafter in more detail. For example, the user can enter the user item and the secret code through the microphone 206 with a voice thereof. The MCU 108 shown in FIG. 1 uses the control program in the memory 104 shown in FIG. 1 to recognize the voice to obtain the user item and the secret code and then, the user item and the secret code are the shown by the Braille display 102 for the user by turns. When the user touch the right user item and the right secret code he or she wants, the user can push the two ways of keypads 204 at the same time or scan his or her fingerprint via the fingerprint access device 202 to enter, save the user item and the secret code into the memory 104 shown in FIG. 1. Afterward, the user can scan his fingerprint via the fingerprint access device 202 to access the secret codes in the memory 104 and use the keypads 204 to selectively show all user items with the secret codes on the Braille display 102 for the user to have the desired information.

In all embodiments mentioned above, if the user wants to access the hand cryptographic device via the computer or the portable electronic device coupled with, a corresponding software program installed in the computer or the portable electronic device may be necessary for the user to control the hand cryptographic device, such as, the user can pre-set the command of accessing the secret codes, input the secret codes into the hand cryptographic device or delete the secret codes stored in the memory via the computer.

As is understood by a person skilled in the art, the foregoing preferred embodiments of the present invention are illustrative rather than limiting of the present invention. It is intended that they cover various modifications and similar arrangements be included within the spirit and scope of the appended claims, the scope of which should be accorded the broadest interpretation so as to encompass all such modifications and similar structure.

What is claimed is:

1. A hand cryptographic device, comprising:
an input module for being inputted at least one secret code and at least one command of accessing the secret code;
a memory for storing the secret code;
a user interface for providing the secret code stored in the memory; and
a controller for controlling the memory to store the secret code while receiving the secret code from the input module, and for controlling the user interface to provide the secret code stored in the memory while receiving the command of accessing the secret code form the input module.

2. The hand cryptographic device of claim 1, wherein the input module comprises keypads.

3. The hand cryptographic device of claim 1, wherein the memory further stores a control program, and the input module comprises a microphone to receive at least one voice and the controller uses the control program to transform the voice into the secret code or the command of accessing the secret code.

4. The hand cryptographic device of claim 1, wherein the input module comprises a fingerprint access device to scan at least one fingerprint as the command of accessing the secret code.

5. The hand cryptographic device of claim 4, wherein the controller recognizes whether the scanned fingerprint is a correct fingerprint pre-stored in the memory.

6. The hand cryptographic device of claim 1, wherein the user interface is a LCD/OLED display or a touch panel display.

7. The hand cryptographic device of claim 1, wherein the user interface is a speaker controlled by the controller to play at least one voice of the secret code.

8. The hand cryptographic device of claim 1, wherein the user interface is a Braille display.

9. The hand cryptographic device of claim 1, further comprising a communication interface to couple with a computer or a portable electronic device, and the secret code and the command of accessing the secret codes can be inputted via the computer or the portable electronic device.

10. The hand cryptographic device of claim 9, being controlled by a corresponding software program installed in the computer or the portable electronic device.

11. The hand cryptographic device of claim 9, wherein the communication interface is a USB interface or an IEEE 1394 interface.

12. The hand cryptographic device of claim 1, wherein the controller is a micro control unit (MCU).

13. The hand cryptographic device of claim 1, further comprising a storage unit for storing data.
